(19) United States
(12) Patent Application Publication
(10) Pub. No.: US 2008/0145587 A1
(43) Pub. Date: Jun. 19, 2008

(54) OPTICAL RECORDING MEDIUM

(75) Inventors: Hajime YUZURIHARA, Odawara-shi (JP); Hiroyuki Iwasa, Yokohama-shi (JP); Katsunari Hanaoka, Atsugi-shi (JP); Kiyoto Shibata, Isehara-shi (JP); Yujiro Kaneko, Tokyo (JP)

Correspondence Address: COOPER & DUNHAM, LLP, 1185 AVENUE OF THE AMERICAS, NEW YORK, NY, 10036, US

(73) Assignee: Ricoh Company, Ltd,, Tokyo (JP)

(21) Appl. No.: 12/029,213

(22) Filed: Feb. 11, 2008

Related U.S. Application Data
(63) Continuation of application No. PCT/JP2006/316439, filed on Aug. 16, 2006.

(30) Foreign Application Priority Data
Aug. 25, 2005 (JP) 2005-244486

(51) Int. Cl. G11B 7/242

(52) U.S. Cl. 428/64.4

(57) ABSTRACT

It is an object of the present invention to provide an optical recording medium containing a substrate, and a reflective layer, a second dielectric layer, a recording layer and a first dielectric layer which are disposed over the substrate in this order, wherein the recording layer contains a phase-change recording material containing any one of GeSbSnMn and GeSbSnMnGa, and the second dielectric layer contains an oxide of two or more elements of Nb, Si and Ta.

### CROSS-REFERENCE TO RELATED APPLICATION

This is a continuation of Application No. PCT/JP2006/316439, filed on Aug. 16, 2006.

### BACKGROUND OF THE INVENTION

1. Field of the Invention

The present invention relates to an optical recording medium on which performing high-density and high-speed recording and reproducing of information is possible by using a laser beam.

2. Description of the Related Art

The phase-change optical discs are used as rewritable optical discs in recent years. In particular, there are disc specifications for each CD-RW, DVD+RW, DVD-RW and DVD-RAM. However, optical discs on which recording and reproducing of information of larger volumes are possible are demanded and full-scale development of digital broadcasting infrastructure which handles high quality, high-resolution images and development for storage of large volume files containing image information in the office are in progress. With that, higher density and speeding up of write speed are being demanded simultaneously.

There have been various proposals for higher density; however, a method for achieving high-density recording by further increasing numerical apertures of optical pickups is employed for next-generation DVD which is expected to form a large market from here on. In particular, the optical pickup has a wavelength of 405 nm and NA of 0.65 to 0.85.

The phase-change optical discs have multilayer structures containing plastic substrate, dielectric material, chalcogen-based phase-change recording material, dielectric material and Al or Ag alloy, or containing plastic substrate, Al or Ag alloy, dielectric material, chalcogen-based phase-change recording material and dielectric material, or multilayer structures with more layers further containing interface layer which is in contact with the recording layer. The chalcogen-based phase-change recording material has a crystalline or non-crystalline structure depending on its thermal history and discrimination of recorded information can be performed by the difference in reflectance.

With larger volumes, demand for high-speed recording of information is increased. One of the points that need to be in consideration for speeding up is heat conductivity of reflective layers and in addition, lower noise which is caused by the surface structure. The typical materials for the reflective layers include Ag, Au and Cu and these are used as alloys instead of single element in order to achieve high heat conductivity and lower noise. However, it is impossible to obtain sufficient recording performance only by using the reflective layers of high heat conductivity.

The next important point is the dielectric material between reflective layers and recording layers.

Property values of the dielectric material such as heat conductivity and specific heat which govern recording sensitivity preferably have a tendency to be lower. In general, temperature of the recording layer is increased by using optical pulses. Since the pulse time is in nano-order, it is preferable to heat the recording layer up to the required temperature in a short period of time and then to release heat. The typical dielectric material include a mixture of ZnS and SiO₂, and the mixture with a ratio (mol %) of 80:20 is mainly used. And other dielectric material include metal oxides, nitrides and carbides with high optical transparencies (Japanese Patent Application Laid-Open (JP-A) No. 10-208299).

Further, when the dielectric layer contains a material including S such as the mixture of ZnS and SiO₂ and the reflective layer contains Ag or an alloy containing 90% by mass or more of Ag, a particular issue arises such that the reflective layer corrodes in high temperature, high humidity environment by sulfuration reaction of Ag, therefore, a composition in which a layer which suppresses sulfuration reaction of Ag is added between these layers is further employed (JP-A No. 2002-74746).

When only carbides are used for the dielectric layer between reflective layers and recording layers, an increase in optical constant k from one digit to four digits as compared to oxides becomes a problem. As a result, reflectance as a medium signal may be lowered or sensitivity may be degraded (laser power necessary for writing is increased). Moreover, since many types of carbide are used as mold materials for glass press lens or surface layer of molds, many of them are thought to have inappropriate adhesion with chalcogenide material for recording layers or dielectric layer materials which are equivalent to glass materials that are in contact with recording layer materials. Furthermore, even though carbides are strong against thermal shock, many types of carbide have high heat conductivities and are thought to require high write power because energy power applied from the semiconductor laser escapes to the reflective layer side through carbide layers.

As described above, Ag or Ag alloy of high heat conductivity is used for reflective layer material as the phase-change optical recording medium becomes of higher velocity. In order to eliminate medium defects caused by sulfuration at high temperature, high humidity environment when using the mixture of ZnS and SiO₂ as dielectric material, it is necessary to dispose a barrier layer between dielectric layers and reflective layers. Furthermore, there is a case that it is impossible to obtain sufficient recording performance only with materials and compositions of the recording layers for high-velocity recording. In this case, it is necessary to improve overwriting performance with higher crystallization speed. Moreover, dielectric layers which are in contact with the recording layer and exhibit accelerated effect for crystallization are added and in some cases, it is necessary to dispose the dielectric layers on both sides of recording layers. In that case, number of layers is increased more and more, resulting in a problem of high production cost of the optical recording medium.

### BRIEF SUMMARY OF THE INVENTION

An object of the present invention is to provide an optical recording medium of low-cost, on which high-velocity recording is possible, which can ensure recording performance and storage reliability.

To settle above issues, a study has been conducted on how to obtain an optical recording medium of four-layer structure containing Ag or Ag alloy reflective layer, a second dielectric layer, a recording layer and a first dielectric layer with appropriate recording performance by substituting the mixture of ZnS and SiO₂ containing sulfur (S), which is a typical dielectric material used in between reflective layers and recording layers, with other dielectric material. As a result, not only appropriate properties were obtained near the linear velocity of 20 m/s or more but also storage reliability of recording mark was ensured by using GeSbSnMn or GeSbSnMnGa for the recording layers and a combination of oxides of 2 or more elements of Nb, Si and Ta for the second dielectric layer which was in contact with the recording layers.

Moreover, when recording was performed using an optical system of 650 nm laser wavelength and objective lens of NA 0.65 with the composition described as above, recording sensitivity was significantly degraded compared to the case when the mixture of ZnS and SiO₂ was used for the second dielectric layer and in addition, the optical recording medium would not be practical for use because of insufficient initial recording performance and the decrease in reflectance. However, it has been found that for the optical recording medium on which recording is performed using an optical system of 405 nm laser wavelength and objective lens of NA 0.85, it is possible to obtain sufficient recording performance at approximately 20 m/s recording linear velocity or higher linear velocity by combining the second dielectric layer material which is a combination of oxides of 2 or more elements of Nb, Si and Ta with a GeSb-based phase-change recording material containing 50 atomic % or more of Sb.

The present invention is based on the findings of the present inventors and the measures to solve above-mentioned problems are as follows:

<1> An optical recording medium containing a substrate, a reflective layer, a second dielectric layer, a recording layer, and a first dielectric layer, wherein the reflective layer, the second dielectric layer, the recording layer and the first dielectric layer are disposed over the substrate in this order, the recording layer contains a phase-change recording material containing any one of GeSbSnMn and GeSbSnMnGa, and the second dielectric layer contains an oxide of two or more elements of Nb, Si and Ta.
<2> The optical recording medium as stated in above <1>, wherein the optical recording medium contains an optical transmission layer, the first dielectric layer, the recording layer, the second dielectric layer, the reflective layer and the substrate in this order from the light irradiation side.
<3> The optical recording medium as stated in any one of above <1> and <2>, wherein the oxide in the second dielectric layer is composed of any one of Nb₂O₅ and SiO₂, and Ta₂O₅ and SiO₂.
<4> The optical recording medium as stated in above <3>, wherein the component ratio of Nb₂O₅ or Ta₂O₅, α (mol %) and the component ratio of SiO₂, 6 (mol %) satisfy the next equations, 30≦α≦85 and β=100−α.
<5> The optical recording medium as stated in any one of above <1> and <2>, wherein the oxide in the second dielectric layer is Nb₂O₅, SiO₂, and Ta₂O₅.
<6> The optical recording medium as stated in above <5>, wherein the component ratio of Nb₂O₅, α′ (mol %), the component ratio of SiO₂, β′ (mol %) and the component ratio of Ta₂O₅, γ′ (mol %) satisfy the next equation, 30≦α′≦85, 10≦β′≦50 and γ′=100−(α′+β′).
<7> The optical recording medium as stated in any one of above <1> to <6>, wherein the thickness of the second dielectric layer is 3 nm to 15 nm.
<8> The optical recording medium as stated in any one of above <1> to <7>, wherein the first dielectric layer contains ZnS and SiO₂ and the ratio of SiO₂ is 15 mol % to 40 mol %.
<9> The optical recording medium as stated in any one of above <1> to <8>, wherein the reflective layer contains any one of Ag and Ag alloy.

### BRIEF DESCRIPTION OF THE SEVERAL VIEWS OF THE DRAWING

FIG. 1 is a schematic diagram showing an exemplary optical recording medium of the present invention.

### DETAILED DESCRIPTION OF THE INVENTION

The optical recording medium of the present invention contains a substrate, and a reflective layer, a second dielectric layer, a recording layer and a first dielectric layer over the substrate, and further contains other layers as necessary.

It is preferable, in this case, that the optical recording medium contain an optical transmission layer, the first dielectric layer, the recording layer, the second dielectric layer, the reflective layer and the substrate in this order from the light irradiation side.

### —Recording Layer—

The recording material suitable for recording at a high linear velocity of 20 m/s or more is used for the recording layer. The recording material, GeSbTeInAg, which has been used conventionally, improves reliability by addition of Ge, In and Ag in the SbTe eutectic-like composition. The eutectic-like composition of SbTe here is the SbTe eutectic-like composition which satisfies 70≦Sb≦80 and 20≦Te≦30. Since the recording material is suitable for relatively slow linear velocity of less than 15 m/s, it is inadaptable for the optical system of 405 nm laser wavelength and objective lens of NA of more than 0.65 for which has been adjusted for high density recording. Moreover, when reproducing power for reproducing recording signals increases, additive element, In drastically degrades reproducing properties. And as the recording linear velocity increases, stability of recording marks in high temperature, high humidity environment is degraded and marks may disappear. As a measure to settle above issues, a method for suppressing the problems with addition of other additive elements may be employed, however, a problem of stability still remains with a linear velocity of 20 m/s to 30 m/s or more.

On the other hand, although GeSb recording material is suitable for high linear velocity recording in the range of 10 atomic % to 15 atomic % of Ge and 85 atomic % to 90 atomic % of Sb, it is not practical for use as a binary system of GeSb because of small modulation degree and low reflectance. However, it has been found that even when the recording marks are recorded at a low linear velocity of approximately 5 m/s and placed in high temperature environment for several hundred hours, signals are hardly degraded. With that, studies were conducted on Sn, In, Ga, Ag, Zn and Bi as third additive elements in order to improve properties for making it applicable for recording at high linear velocity.

As a result, it has been found that the addition of Sn is effective, and simultaneous pursuit of recording at high linear velocity and property improvement is possible in the range of 15 atomic % to 25 atomic % of Sn. Since appropriate properties at high linear velocity could not be obtained with more than 25 atomic % of Sn, it was adjusted with the content ratio of Ge and Sb, however, properties tend to vary with varying composition at a linear velocity of more than 20 m/s. In was further added for trial, however, property degradation was significant relative to the number of repeated reproducing. It was also the same for Bi. In addition, it turns out that Ag and Zn are not suitable for high linear velocity.

When amount of Ge was decreased and Mn was added just that much, properties at high linear velocity did not change and it turns out that data storage ability in high temperature, high humidity environment is appropriate. Moreover, it also turns out that power margin relative to write power is widened and property variation due to composition change is small. The preferred composition range is 1 atomic % to 10 atomic %.

Furthermore, recording performance was more improved by addition of Ga.

From the result of study above, it was concluded that the optimal recording materials are GeSbSnMn and GeSbSnMnGa. The optimal composition ranges of each element in atomic % are 5≦Ge≦15, 55≦Sb≦70, 15≦Sn≦25, 1≦Mn≦7 and 0≦Ga≦7 relative to the recording linear velocity of 15 m/s to 30 m/s.

### —Second Dielectric Layer—

The study on the second dielectric layer was conducted by using the above recording materials for further improvement of recording performance. With regard to the mixture of ZnS and SiO₂ which has been used conventionally, the recording performance is likely to be improved as the thickness of the layer using the mixture of ZnS and SiO₂ becomes thinner when an optical system of 405 nm laser wavelength and objective lens of NA 0.85 is used for recording. However, if the thickness becomes as thin as several nm, properties do not get better any more and sensitivity is degraded. And because the recording properties do not reach the desired value, a study on a material of higher radiation performance as an alternative to the mixture of ZnS and SiO₂ was conducted. The material is preferably having higher heat conductivity than that of the mixture of ZnS and SiO₂ and lower heat conductivity than that of metals and alloys. With that, studies were conducted with a focus on oxides.

When single carbide is used, adhesion between the second dielectric layer and Ag reflective layer is degraded, and when the medium was left unattended in high temperature, high humidity environment, a number of lifting and peeling of films may occur. At the same time, reflectance is lowered due to the large value of optical constant k of the thin film made of single carbide and because the heat conductivity is ten times higher than that of ZnS:SiO₂=80:20 (mol %), both of recording sensitivity and properties are degraded. The same tendency is observed with single nitride.

Furthermore, it is advantageous to use materials which do not contain sulfur as an alternative to the mixture of ZnS and SiO₂ because it allows to have fewer layers, a 4-layer structure containing a first dielectric layer, a recording layer, a second dielectric layer and a reflective layer. A number of layers in the phase-change optical recording medium have been increasing like disposing a sulfuration-inhibiting layer between second dielectric layers and reflective layers, or disposing an interface layer between first dielectric layers and recording layers. Therefore, reducing the number of layers is advantageous in terms of cost. However, when recording performance is unsatisfactory with the 4-layer structure only, other layers may be disposed as necessary although preserving advantages of reduced number of layers needs to be in consideration.

It has been found that the material, which contains an oxide of 2 or more types of Nb, Si and Ta as a main component, excels as a material for the second dielectric layer used in the present invention because it has higher heat conductivity than that of the mixture of ZnS and SiO₂ and lower heat conductivity than that of single carbide and single nitride, a high melting point and is transparent. Being main component in here means that it is satisfactory in the amount for exhibiting properties of each oxide. In general, it is preferably 70 mol % or more.

Generally, materials only containing oxides of above elements are used; however, compounds for improving recording performance or elements for increasing film-forming rate, which will be described later, may be added as necessary.

In general, oxides of 2 or more types of Nb, Si and Ta are used as mixtures.

Moreover, since the oxides of Nb, Si and Ta do not contain S elements, storage reliability is appropriate when reflective layers containing Ag as main component is used in contact with the oxides.

Heat conductivity and refractive index may be adjusted by changing the ratio of Nb, Si and Ta. For example, if the ratio of Nb is increased, that is, if the ratio of Nb₂O₅ is increased, refractive index is increased (the refractive index becomes approximately 2.1 to 2.3 with Nb₂O₅ only). It is the same for Ta₂O₅. Contrary to above, if the ratio of SiO₂ is increased, refractive index is decreased to approximately 1.4.

Examples of combination include (Nb₂O₅, SiO₂), (Ta₂O₅, SiO₂), (Nb₂O₅, SiO₂, Ta₂O₅), and the like.

The ratio of each oxide of (Nb₂O₅, SiO₂) and (Ta₂O₅, SiO₂) is preferably satisfying the relations of 30≦α≦85 and β=100−α with the component ratio of Nb₂O₅ or Ta₂O₅ being a (mol %) and the component ratio of SiO₂ being B (mol %). When α<30, recording sensitivity and properties are degraded and when α>85, recording sensitivity and overwriting performance are degraded.

The ratio of oxide of (Nb₂O₅, SiO₂, Ta₂O₅) is preferably satisfying the relations of 30≦α′≦85, 10≦β′≦50 and γ′=100−(α′+β′) with the component ratio of Nb₂O₅ being α′ (mol %), the component ratio of SiO₂ being β′ (mol %), and the component ratio of Ta₂O₅ being γ′ (mol %). When α′<30, recording sensitivity and properties are degraded, and when α′85, recording sensitivity and overwriting performance may be degraded. Further, when β′>50, recording sensitivity and properties are degraded, and when β′<10, overwriting performance is degraded. The preferred range is 40 to 80 for Nb₂O₅ (α′), 10 to 30 for SiO₂ (β′), and 5 to 50 for Ta₂O₅ (γ′).

The oxygen amount in the composition, in which the oxides of the above compositions are used, of the second dielectric layer prepared by using a sputtering target include the amount less than the intended amount such as Nb₂O_{(5-δ) and SiO}_{(2-δ)}. The preferred value for δ is 0.5 atomic % at most.

Moreover, materials having high transparencies and high melting points such as oxides, sulfides, nitrides and carbides of metals or semiconductors may be added in the material for the second dielectric layer. Specific examples include metal oxides of ZnO, SnO₂, Al₂O₃, TiO₂, In₂O₃, MgO, ZrO₂, CeO₂ and the like; nitrides of Si₃N₄, AlN, TiN, BN, ZrN, and the like; sulfides of ZnS, TaS₄, and the like; and carbides of SiC, TaC, B₄C, WC, TiC, ZrC, and the like. For example, heat expansion coefficient is increased by adding crystalline ZnO or CeO₂, thereby improving overwriting performance. With regard to other additives, recording performance is relatively appropriate with a mixture of TiO and TiC even though reflectance is lowered.

The thickness of the second dielectric layer is preferably 3 nm to 15 nm and more preferably 5 nm to 10 nm. If the thickness is less than 3 nm, mechanical strength is degraded and the medium may not be suitable for rewriting. Furthermore, because large portion of the laser energy is transmitted to the reflective layer, making molten regions small, thus modulation degree is lowered and recording sensitivity is degraded. On the other hand, if the thickness is more than 15 nm, heat release effect is not only degraded making it impossible to obtain a quenching structure, but cross erases between adjacent tracks or heat interferences between sequencing marks may also be increased.

The second dielectric layer may be prepared by sputtering using a target of mixed oxide, for example. However, the film-forming rate of the mixed oxide is as slow as one forth or less of the mixture of ZnS and SiO₂ and cost is increased in terms of productivity. In other words, number of production per unit of time is decreased. Therefore, it is preferable to increase the film-forming rate by adding V, Ni, Zr, W, Mo and Nb. Of these, Ni is the most effective. The additive amount of the additive elements is preferably 3 atomic % to 7 atomic %.

The optical recording medium of the present invention is preferably used for the medium for high-density recording using an optical system with a laser wavelength of 405 nm and objective lens of NA 0.85.

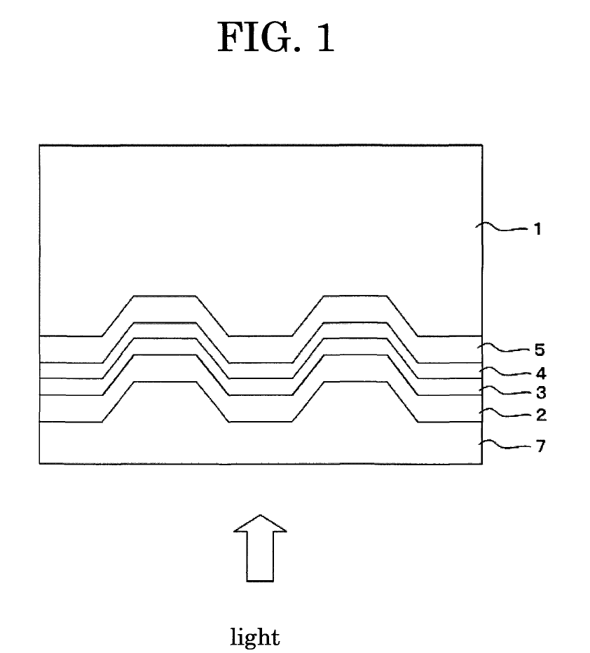

In FIG. 1, an optical transmission layer 7, a first dielectric layer 2, a recording layer 3, a second dielectric layer 4, a reflective layer 5 and a substrate 1 are formed in this order as seen from the light irradiation side.

### —Substrate—

The substrate of the optical recording medium of the present invention does not need to be transparent because it is not composed as to irradiate light from the substrate side. Examples of substrate material include glasses, ceramics and resins and resin substrate is suitable for its excellent formability and cost. Examples of resins include polycarbonate resin, acrylic resin, epoxy resin, polystyrene resin, acrylonitrile-styrene copolymer resin, polyethylene resin, polypropylene resin, silicon resin, fluorine resin, ABS resin and urethane resin. Of these, polycarbonate resin and acrylic resin are preferable for their excellent formability, optical properties and cost. Moreover, resins may be of cornstarch material extracted from paper or plants, for example.

The substrates, which are formed so as to have size, thickness and groove forms that meet the governing standards, are used.

### —First Dielectric Layer—

Examples of the material for the first dielectric layer include oxides such as SiO, SiO₂, ZnO, SnO₂, Al₂O₃, TiO₂, In₂O₃, MgO and ZrO₂; nitrides such as Si₃N₄, AlN, TiN, BN and ZrN; sulfides such as ZnS and TaS₄; carbides such as SiC, TaC, B₄C, WC, TiC and ZrC; or mixtures of these. Of these, mixtures of ZnS and SiO₂ with a ratio of ZnS:SiO₂=60:40 to 85:15 (mol %) are preferable and a mixture of ZnS:SiO₂=70:30 (mol %), which has higher heat conductivity, is particularly preferable in terms of overwriting performance.

The thickness of the first dielectric layer is preferably the thickness with which a medium reflectance value approaches near the minimum in relation with the thickness of the first dielectric layer because it significantly affects reflectance, modulation degree and recording sensitivity. The recording sensitivity is appropriate in this thickness region and overwriting performance can be improved. Furthermore, it is preferable because properties are stabilized even with the variation in thickness. Therefore, the thickness of the first dielectric layer is preferably 30 nm to 50 nm. When the thickness is less than 30 nm, overwriting properties may be degraded and reflectance may be decreased. When the thickness is more than 50 nm, although reflectance may be increased, recording sensitivity may be degraded.

### —Reflective Layer—

The metals containing Ag, Au and Cu as main components are used for the reflective layers. Ag, which has high heat conductivity and is relatively inexpensive, is preferable; however, particle diameter of the films made of single Ag is large, causing the thickness of boundary portion of each particle to vary, resulting in surface roughness. When the surface is flattened by addition of 5 atomic % or less of elements such as Cu, Pd, Nd, Pt and Bi to Ag, the noise due to surface roughness is reduced and recording performance is improved because the signal noise is affected by the surface profile of the reflective layers.

The thickness of the reflective layers is preferably in the range of 80 nm to 200 nm. When the thickness is less than 80 nm, heat conductivity is decreased and recording performance is degraded. The recording performance does not change even when the thickness is more than 200 nm, however, when the thickness is more than 250 nm, mechanical properties are degraded because of the increase in warpage and deformation of the optical recording medium and the recording performance may also be degraded.

In the present invention, an optical recording medium is produced by forming a reflective layer, a second dielectric layer, a recording layer and a first dielectric layer over a substrate, and then forming an optical transmission layer, which correspond to the substrate portion of CD and DVD, over these layers.

The thickness of the optical transmission layer is preferably set at 0.1 mm in order for the irradiated light to focus on the recording layer. By this, aberration is suppressed to its minimum and performance margin is widened relative to the tilt of the optical recording medium. The thickness of the optical transmission layer is preferably uniform in the entire surface of the optical recording medium and precision level of ±2 μm is required. However, since it is still inadequate, it is preferable to dispose an aberration correction system in the optical system of the recording apparatus to obtain stable performance relative to the variation in thickness.

By the present invention, an optical recording medium on which recording and reproducing by means of an optical system with a laser wavelength of 405 nm and an objective lens of NA 0.85 are possible, which exhibits excellent recording performance even at the time of recording at high linear velocity and has appropriate storage reliability can be provided. Furthermore, an optical recording medium which exhibits appropriate overwriting performance even at the time of recording at high linear velocity by optimization of the composition ratio of ZnS and SiO₂ in the first dielectric layer can also be provided.

### EXAMPLES

The invention will be explained in detail referring to Examples and Comparative Examples below, and the following Examples and Comparative Examples should not be construed as limiting the scope of this invention.

### Examples 1 to 5

### Preparation of Optical Recording Medium

Substrates made of polycarbonate resin having a diameter of 12 cm and a thickness of 1.1 mm, on which grooves were formed, were used. The pitch between grooves was 0.32 μm, width of the pitch in which information was recorded was 0.165 μm and depth of the groove was 22 nm.

Films were formed on the substrate in sequence using a magnetron sputtering apparatus, DVD-Sprinter by Unaxis.

First, reflective layers of 140 nm thickness were formed using a target of Ag—Bi (Bi content: 0.5 atomic %).

Next, second dielectric layers of 5 different thicknesses as shown in Table 1 were formed on the reflective layers respectively using a target of Nb₂O₅:SiO₂=85:15 (mol %).

And recording layers of 14 nm thickness were then formed on the second dielectric layers of 5 different thicknesses using a target with a composition of Ge_{9.5}Sb₆₆Sn₁₈Mn_{6.5} (atomic %).

Next, first dielectric layers of 40 nm thickness were formed on the recording layers using a target of ZnS:SiO₂=70:30 (mol %).

Finally, sheets made of polycarbonate resin (“PURE-ACE” by Teijin Chemicals Ltd.) of 75 μm thickness were bonded on the first dielectric layers with an ultraviolet-curable resin (DVD003 by Nippon Kayaku Co., Ltd.) of 25 μm thickness. The optical recording media of Examples 1 to 5 were prepared as described above.

### —Initialization—

Next, recording layers of each optical recording medium were crystallized under a condition of 3 m/s linear velocity, 800 mW power and 36 μm head feed using an initialization apparatus (by Hitachi Systems & Services, Ltd.).

### <Evaluation>

The signal properties for each of the above optical recording media were evaluated using a recording/reproducing apparatus (DDU-1000 by Pulstec Industrial Co., Ltd.) having a pickup head of 405 nm wavelength and NA 0.85.

The recording linear velocity was 19.86 m/s, write power (Pw) was 10 mW to 12 mW and erase power (Pe) was set at 30% of Pw. Each mark from the shortest recording mark of 2T length to the recording mark of 8T length was recorded randomly with a pair of a pulse which irradiated Pw and a pulse which irradiated bottom power (Pb), which was equivalent to the reproducing power or less. The shortest mark length 2T corresponded to 0.149 μm. The number of pair for each pulse 2T, 3T, 4T, 5T, 6T, 7T and 8T was set as 1, 1, 2, 2, 3, 3 and 4. The irradiation time for each pulse was adjusted so as to optimize recording performance. The spaces between marks were irradiated sequentially with erase power.

Jitter was measured as a recording property. The optimum write power Pw (mW) and jitter after 10 times of direct-overwriting are shown in Table 1.

TABLE 1

| | Thickness of Second | | |
|---|---|---|---|
| | Dielectric Layer (nm) | Jitter (%) | Pw (mW) |
| Example 1 | 3 | 8.9 | 11.0 |
| Example 2 | 8 | 7.5 | 10.5 |
| Example 3 | 15 | 9.0 | 11.0 |
| Example 4 | 2 | 9.5 | 12.0 |
| Example 5 | 16 | 10.2 | 12.0 |

From the result shown in Table 1, it turns out that the thicknesses of the second dielectric layer in Examples 1 to 3 were in the range of 3 nm to 15 nm and jitter values were 9% or less. On the other hand, since the thicknesses of the second dielectric layer in Examples 4 and 5 were out of the range, jitter values were more than 9%.

Furthermore, when jitters were measured for each optical recording medium of Examples 1 to 5 after each medium was left unattended in an environment of 80° C. and 85% RH for 300 hours after recording, no change was observed.

### Example 6

### Preparation of Optical Recording Medium

A substrate made of polycarbonate resin having a diameter of 12 cm and a thickness of 1.1 mm, on which grooves were formed, was used. The pitch between grooves was 0.32 μm, width of the pitch in which information was recorded was 0.165 μm and depth of the groove was 22 nm.

Films were formed on the substrate in sequence using a magnetron sputtering apparatus, DVD-Sprinter by Unaxis.

First, a reflective layer of 140 nm thickness was formed using a target of Ag—Bi (Bi content: 0.5 atomic %).

Next, a second dielectric layer of 8 nm thickness was formed on the reflective layer using a target of Nb₂O₅:SiO₂=85:15 (mol %).

A recording layer of 14 nm thickness was then formed on the second dielectric layer using a target with a composition of Ge_{5.5}Sb₆₆Sn₁₈Mn_{6.5}Ga₄ (atomic %).

Next, a first dielectric layer of 40 nm thickness was formed on the recording layer using a target of ZnS:SiO₂=70:30 (mol %).

Finally, a sheet made of polycarbonate resin (“PURE-ACE” by Teijin Chemicals Ltd.) of 75 μm thickness was bonded on the first dielectric layer with an ultraviolet-curable resin (DVD003 by Nippon Kayaku Co., Ltd.) of 25 μm thickness. The optical recording medium of Example 6 was prepared as described above.

### —Initialization—

Next, the recording layer was crystallized under a condition of 3 m/s linear velocity, 800 mW power and 36 μm head feed using an initialization apparatus (by Hitachi Systems & Services, Ltd.).

### <Evaluation>

The signal property of the above optical recording medium was evaluated using a recording/reproducing apparatus (DDU-1000 by Pulstec Industrial Co., Ltd.) having a pickup head of 405 nm wavelength and NA 0.85.

The recording linear velocity was 19.86 m/s, write power (Pw) was 10 mW to 12 mW and erase power (Pe) was set at 30% of Pw. Each mark from the shortest recording mark of 2T length to the recording mark of 8T length was recorded randomly with a pair of a pulse which irradiated Pw and a pulse which irradiated bottom power (Pb), which was equivalent to the reproducing power or less. The shortest mark length 2T corresponded to 0.149 μm. The number of pair for each pulse 2T, 3T, 4T, 5T, 6T, 7T and 8T was set as 1, 1, 2, 2, 3, 3 and 4. The irradiation time for each pulse was adjusted so as to optimize recording performance. The spaces between marks were irradiated sequentially with erase power.

The measured jitter after 10 times of direct-overwriting was 7% and it showed that the properties were further improved by addition of Ga.

### Examples 7 to 28

Substrates made of polycarbonate resin having a diameter of 12 cm and a thickness of 1.1 mm, on which grooves were formed, were used. The pitch between grooves was 0.32 μm, width of the pitch in which information was recorded was 0.165 μm and depth of the groove was 22 nm.

Films were formed on the substrate in sequence using a magnetron sputtering apparatus, DVD-Sprinter by Unaxis.

First, reflective layers of 140 nm thickness were formed using a target of Ag—Bi (Bi content: 0.5 atomic %).

Next, second dielectric layers of 8 nm thickness were formed on the reflective layers using a target of Nb₂O₅.SiO₂, Ta₂O₅SiO₂ and Nb₂O₅.SiO₂ Ta₂O₅ respectively.

Recording layers of 14 nm thickness were then formed on the second dielectric layers using a target with a composition of Ge_{5.5}Sb₆₆Sn₁₈Mn_{6.5}Ga₄ (atomic %).

Next, first dielectric layers of 40 nm thickness were formed on the recording layers using a target of ZnS:SiO₂=70:30 (mol %).

Finally, sheets made of polycarbonate resin (“PURE-ACE by Teijin Chemicals Ltd.) of 75 μm thickness were bonded on the first dielectric layers with an ultraviolet-curable resin (DVD003 by Nippon Kayaku Co., Ltd.) of 25 μm thickness. The optical recording media of Examples 7 to 28 were prepared as described above.

### —Initialization—

Next, recording layers were crystallized under a condition of 3 m/s linear velocity, 800 mW power and 36 μm head feed using an initialization apparatus by Hitachi Systems & Services Ltd.

### <Evaluation>

The signal properties for each of the above optical recording medium were evaluated using a recording/reproducing apparatus (DDU-1000 by Pulstec Industrial Co., Ltd.) having a pickup head of 405 nm wavelength and NA0.85. The recording linear velocity was 19.86 m/s, write power (Pw) was 10 mW to 12 mW and erase power (Pe) was set at 30% of Pw. Each mark from the shortest recording mark of 2T length to the recording mark of 8T length was recorded randomly with a pair of a pulse which irradiated Pw and a pulse which irradiated bottom power (Pb), which was equivalent to the reproducing power or less. The shortest mark length 2T corresponded to 0.149 μm. The number of pair for each pulse 2T, 3T, 4T, 5T, 6T, 7T and 8T was set as 1, 1, 2, 2, 3, 3 and 4. The irradiation time for each pulse was adjusted so as to optimize recording performance. The spaces between marks were irradiated sequentially with erase power.

Jitter was measured as a recording property. The results are shown in Table 2.

TABLE 2

| | Composition of Second Dielectric | | |
|---|---|---|---|
| | Layer (mol %) | Jitter (%) | Pw (mW) |
| Example 7 | (Nb₂O₅)₃₀SiO₂)₇₀ | 8.2 | 10.5 |
| Example 8 | (Nb₂O₅)₈₀(SiO₂)₂₀ | 7.5 | 10.5 |
| Example 9 | (Nb₂O₅)₈₅(SiO₂)₁₅ | 7.2 | 10.5 |
| Example 10 | (Ta₂O₅)₃₀(SiO₂)₇₀ | 8.5 | 10.5 |
| Example 11 | (Ta₂O₅)₈₀(SiO₂)₂₀ | 8.1 | 10.0 |
| Example 12 | (Ta₂O₅)₈₅(SiO₂)₁₅ | 8.6 | 10.5 |
| Example 13 | (Nb₂O₅)₃₀(SiO₂)₁₀(Ta₂O₅)₆₀ | 8.0 | 10.5 |
| Example 14 | (Nb₂O₅)₄₅(SiO₂)₁₅(Ta₂O₅)₄₀ | 7.5 | 10.5 |
| Example 15 | (Nb₂O₅)₆₅(SiO₂)₁₀(Ta₂O₅)₂₅ | 7.7 | 10.5 |
| Example 16 | (Nb₂O₅)₅₀(SiO₂)₃₀(Ta₂O₅)₂₀ | 8.1 | 10.5 |
| Example 17 | (Nb₂O₅)₈₅(SiO₂)₁₀(Ta₂O₅)₅ | 8.0 | 10.5 |
| Example 18 | (Nb₂O₅)₆₀(SiO₂)₁₅(Ta₂O₅)₂₅ | 8.3 | 10.5 |
| Example 19 | (Nb₂O₅)₃₀(SiO₂)₅₀(Ta₂O₅)₂₀ | 8.4 | 10.5 |
| Example 20 | (Nb₂O₅)₂₉(SiO₂)₇₁ | 10.2 | 12.0 |
| Example 21 | (Nb₂O₅)₈₆(SiO₂)₁₄ | 9.5 | 10.5 |
| Example 22 | (Ta₂O₅)₂₉(SiO₂)₇₁ | 10.0 | 12.0 |
| Example 23 | (Ta₂O₅)₈₆(SiO₂)₁₄ | 9.4 | 11.0 |
| Example 24 | (Nb₂O₅)₂₉(SiO₂)₈(Ta₂O₅)₆₃ | 9.8 | 11.0 |
| Example 25 | (Nb₂O₅)₈₆(SiO₂)₅(Ta₂O₅)₉ | 10.2 | 11.0 |
| Example 26 | (Nb₂O₅)₂₉(SiO₂)₉(Ta₂O₅)₆₂ | 10.5 | 11.0 |
| Example 27 | (Nb₂O₅)₈₀(SiO₂)₅(Ta₂O₅)₁₅ | 9.5 | 11.5 |
| Example 28 | (Nb₂O₅)₃₀(SiO₂)₅₂(Ta₂O₅)₁₈ | 9.4 | 11.0 |

From the results shown in Table 2, it turns out that jitter values after 10 times of direct-overwriting were 9% or less for Examples 7 to 19.

Moreover, jitter values after 10 times of direct-overwriting were more than 9% for Examples 20 to 28 because ratios of components for oxides in the second dielectric layers were out of the preferred range, however, they were within 10.5%.

### Examples 29 to 33

Substrates made of polycarbonate resin having a diameter of 12 cm and a thickness of 1.1 mm, on which grooves were formed, were used. The pitch between grooves was 0.32 μm, width of the pitch in which information was recorded was 0.165 μm and depth of the groove was 22 nm.

Films were formed on the substrate in sequence using a magnetron sputtering apparatus, DVD-Sprinter by Unaxis.

First, reflective layers of 140 nm thickness were formed using a target of Ag—Bi (Bi content: 0.5 atomic %).

Next, second dielectric layers of 8 nm thickness were formed on the reflective layers using a target of Nb₂O₅:SiO₂=80:20 (mol %) respectively.

Recording layers of 14 nm thickness were then formed on the second dielectric layers using a target with a composition of Ge_{9.5}Sb₆₆Sn₁₈Mn_{6.5} (atomic %).

Next, first dielectric layers of 40 nm thickness were formed on the recording layers using a target of ZnS:SiO₂ with 3 different compositions as shown in Examples 18 to 20 in Table 3.

Finally, sheets made of polycarbonate resin (“PURE-ACE” by Teijin Chemicals Ltd.) of 75 μm thickness were bonded on the first dielectric layers with an ultraviolet-curable resin (DVD003 by Nippon Kayaku Co., Ltd.) of 25 μm thickness. The optical recording media of Examples 29 to 33 were prepared as described above.

### —Initialization—

Next, recording layers were crystallized under a condition of 3 m/s linear velocity, 800 mW power and 36 μm head feed using an initialization apparatus by Hitachi Systems & Services Ltd.

### <Evaluation>

The signal properties for each of the above optical recording medium were evaluated using a recording/reproducing apparatus (DDU-1000 by Pulstec Industrial Co., Ltd.) having a pickup head of 405 nm wavelength and NA 0.85.

The recording linear velocity was 19.86 m/s, write power (Pw) was 10 mW to 12 mW and erase power (Pe) was set at 30% of Pw. Each mark from the shortest recording mark of 2T length to the recording mark of 8T length was recorded randomly with a pair of a pulse which irradiated Pw and a pulse which irradiated bottom power (Pb), which was equivalent to the reproducing power or less. The shortest mark length 2T corresponded to 0.149 μm. The number of pair for each pulse 2T, 3T, 4T, 5T, 6T, 7T and 8T was set as 1, 1, 2, 2, 3, 3 and 4. The irradiation time for each pulse was adjusted so as to optimize recording performance. The spaces between marks were irradiated sequentially with erase power.

Jitter was measured as a recording property. Each property at a write power of 11 mW measured at 0 time of direct-overwriting (first recording, DOW0), 10th time (DOW10), 100^{th} time (DOW100) and 1,000^{th} time (DOW1000) is shown in Table 3.

TABLE 3

| | Composition | | | | |
|---|---|---|---|---|---|
| | of First | | | | |
| | Dielectric | | | | |
| | Layer (mol %) | DOW0 | DOW10 | DOW100 | DOW1000 |
| Example 29 | ZnS:SiO2 = | 6.0 | 7.5 | 7.4 | 7.2 |
| | 70:30 | | | | |
| Example 30 | ZnS:SiO2 = | 6.2 | 7.8 | 7.8 | 8.4 |
| | 85:15 | | | | |
| Example 31 | ZnS:SiO2 = | 6.5 | 7.0 | 8.2 | 8.8 |
| | 60:40 | | | | |
| Example 32 | ZnS:SiO2 = | 7.8 | 8.8 | 9.1 | 9.2 |
| | 59:41 | | | | |
| Example 33 | ZnS:SiO2 = | 7.2 | 8.0 | 8.5 | 9.1 |
| | 86:14 | | | | |

From the results shown in Table 3, it turns out that all jitter values for Example 29 to 31 were 9% or less at DOW1000.

Furthermore, jitter values at DOW 1000 for Examples 32 to 33 were slightly more than 9% because ratios of SiO₂ in the mixture of ZnS and SiO₂ in the first dielectric layer were out of the preferred range, that is, 15 mol % to 40 mol %.

### Comparative Example 1

A substrate made of polycarbonate resin having a diameter of 12 cm and a thickness of 1.1 mm, on which grooves were formed, was used. The pitch between grooves was 0.32 μm, width of the pitch in which information was recorded was 0.165 μm and depth of the groove was 22 nm.

Films were formed on the substrate in sequence using a magnetron sputtering apparatus, DVD-Sprinter by Unaxis.

First, a reflective layer of 140 nm thickness was formed using a target of Ag—Bi (Bi content: 0.5 atomic %).

Next, a second dielectric layer of 8 nm thickness was formed on the reflective layer using a target of ZnS:SiO₂=80:20 (mol %).

A recording layer of 14 nm thickness was then formed on the second dielectric layer using a target with a composition of Ge_{9.5}Sb₆₆Sn₁₈Mn_{6.5} (atomic %).

Next, a first dielectric layer of 40 nm thickness was formed on the recording layer using a target of ZnS:SiO₂=70:30 (mol %).

Finally, a sheet made of polycarbonate resin (“PURE-ACE” by Teijin Chemicals Ltd.) of 75 μm thickness was bonded on the first dielectric layer with an ultraviolet-curable resin (DVD003 by Nippon Kayaku Co., Ltd.) of 25 μm thickness. The optical recording medium of Comparative Example 1 was prepared as described above.

### —Initialization—

Next, the recording layer of the optical recording medium of Comparative Example 1 was crystallized under a condition of 3 m/s linear velocity, 800 mW power and 36 μm head feed using an initialization apparatus by Hitachi Systems & Services Ltd.

### <Evaluation>

The signal property of the above optical recording medium was evaluated using a recording/reproducing apparatus (DDU-1000 by Pulstec Industrial Co., Ltd.) having a pickup head of 405 nm wavelength and NA 0.85.

The recording linear velocity was 19.86 m/s, write power (Pw) was 10 mW and erase power (Pe) was set at 30% of Pw. Each mark from the shortest recording mark of 2T length to the recording mark of 8T length was recorded randomly with a pair of a pulse which irradiated Pw and a pulse which irradiated bottom power (Pb), which was equivalent to the reproducing power or less. The shortest mark length 2T corresponded to 0.149 μm. The number of pair for each pulse 2T, 3T, 4T, 5T, 6T, 7T and 8T was set as 1, 1, 2, 2, 3, 3 and 4. The irradiation time for each pulse was adjusted so as to optimize recording performance. The spaces between marks were irradiated sequentially with erase power. Jitter was measured as a recording property and resulted jitter after 10 times of recording (DOW10) was 9.5%.

When jitter was measured after leaving the obtained optical recording medium in an environment of 80° C. and 85% RH for 300 hours, the resulted jitter was 10%, an increase by 1%.

What is claimed is:

1. An optical recording medium, comprising:
a substrate,
a reflective layer,
a second dielectric layer,
a recording layer, and
a first dielectric layer,
wherein the reflective layer, the second dielectric layer, the recording layer and the first dielectric layer are disposed over the substrate in this order,
the recording layer comprises a phase-change recording material comprising any one of GeSbSnMn and GeSbSnMnGa, and
the second dielectric layer comprises an oxide of two or more elements of Nb, Si and Ta.

2. The optical recording medium according to claim 1, wherein the optical recording medium comprises an optical transmission layer, the first dielectric layer, the recording layer, the second dielectric layer, the reflective layer and the substrate in this order from the light irradiation side.

3. The optical recording medium according to claim 1, wherein the oxide in the second dielectric layer is composed of any one of Nb₂O₅ and SiO₂, and Ta₂O₅ and SiO₂.

4. The optical recording medium according to claim 3, wherein the component ratio of Nb₂O₅ or Ta₂O₅, α (mol %) and the component ratio of SiO₂, β (mol %) satisfy the next equations, 30≦α≦85 and β=100−α.

5. The optical recording medium according to claim 1, wherein the oxide in the second dielectric layer is Nb₂O₅, SiO₂, and Ta₂O₅.

6. The optical recording medium according to claim 5, wherein the component ratio of Nb₂O₅, α′ (mol %), the component ratio of SiO₂, β′ (mol %) and the component ratio of Ta₂O₅, γ′ (mol %) satisfy the next equation, 30≦α′≦85, 10≦β′≦50 and γ′=100−(α′+β′).

7. The optical recording medium according to claim 1, wherein the thickness of the second dielectric layer is 3 nm to 15 nm.

8. The optical recording medium according to claim 1, wherein the first dielectric layer comprises ZnS and SiO₂ and the ratio of SiO₂ is 15 mol % to 40 mol %.

9. The optical recording medium according to claim 1, wherein the reflective layer comprises any one of Ag and Ag alloy.
